(19) United States
(12) Patent Application Publication
(10) Pub. No.: US 2023/0375183 A1
(43) Pub. Date: Nov. 23, 2023

(54) ELECTRIC GRILL WITH IMPROVED CONVECTIVE HEAT TRANSFER

(71) Applicant: W.C. Bradley Co., Columbus, GA (US)

(72) Inventors: JAMES D. KRING, Opelika, AL (US); RAMIN KHOSRAVI RAHMANI, Columbus, GA (US); SLEIMAN ABDALLAH, Columbus, GA (US); Thomas Kessler, Columbus, GA (US)

(21) Appl. No.: 18/199,738

(22) Filed: May 19, 2023

Related U.S. Application Data
(60) Provisional application No. 63/343,792, filed on May 19, 2022.

(51) Int. Cl. F24C 7/08; G05D 23/19; F24C 15/32; A47J 37/07; A47J 36/32

(52) U.S. Cl. CPC F24C 7/088; G05D 23/1951; G05D 23/1931; F24C 15/325; A47J 37/0709; A47J 36/32; A47J 37/0754; H05B 2203/005; A47J 2202/00; H02J 7/02

(57) ABSTRACT

A cooking system including a cooking chamber with a cooking surface therein, at least one resistive heating element providing heat to the cooking surface, an alternating current connection for powering the resistive heating element, and a direct current source.

### CROSS-REFERENCE TO RELATED CASES

This application claims the benefit of U.S. provisional patent application Ser. No. 63/343,792, filed on May 19, 2022, and incorporates such provisional application by reference into this disclosure as if fully set out at this point.

### FIELD OF THE INVENTION

This disclosure relates to electric grill in general and, more specifically, to improvement of heating within such grills.

### BACKGROUND OF THE INVENTION

Current electric powered grills use available alternating current (AC) grid power provided to a house to energize a Calrod® heating element. As the voltage is applied to the electrical resistor inside the heating element, the resistance to the electrical current leads to generation of thermal energy inside the heating element. The temperature at the heating element surface increases and its outer surface starts to radiate heat. Radiative heat generated by the heating element provides heat to a cooking surface, which is typically an open cooking grate that shares the same principles with the ones used in convective gas grills.

Grills that generate heat from a combustible fuel (such as gas or charcoal grills) benefit from multiple heat transfer mechanisms including both radiative and convective transfers. Electric grills lack energy transfer into the cooking chamber via mass transfer (e.g., combustion products generated in a gas or charcoal grill). This results in a longer initial warmup time for the grill, a longer recovery time, and lower temperature and heat available for cooking inside the cooking chamber.

A lack of convective heating also contributes to negative impact of heat loss inside the cooking chamber volume after the lid is opened in the middle of cooking. This issue cannot be solely addressed by increasing the rate of energy generation or power intensity in a heating element. In fact, in many cases, even the heat potentially available from the power grid cannot be fully deployed, as the high rate of heat generation in the electrical resistor inside the heating elements leads to thermal damage of the component due to lack of sufficient heat transfer from the component surface into the surrounding air. Moreover, the radiative nature of electrical heating element designs lead to a large portion of the generated heat to be emitted away from the cooking surface.

What is needed is a system and method for addressing the above and related issues.

### SUMMARY OF THE INVENTION

The invention of the present disclosure, in one aspect thereof, comprises a cooking system including a cooking chamber with a cooking surface therein, at least one resistive heating element providing heat to the cooking surface, an alternating current connection for powering the resistive heating element, and a direct current source selectively powering at least one resistive heating element simultaneously with the alternating current connection.

In some embodiments, the direct current source comprises a chemical battery. The direct current source may comprise a capacitor.

The cooking system may further comprise at least one temperature probe measuring a temperature associated with the cooking chamber. The system may include a control circuit that selectively activates the direct current source based upon readings taken from at least one temperature probe. The at least one temperature probe may comprise a cooking chamber temperature probe and a resistive heating element temperature probe. The at least one resistive heating element may comprise at least a first resistive heating element powered by the alternating current connection and at least a second resistive heating element powered by the direct current source. The control circuit may determine whether a difference between a set point temperature and a temperature from at least one probe exceeds a boost threshold before activating the direct current source to power at least one resistive heating element. In some embodiments, the alternating current connection recharges the direct current source.

The system may have an air duct providing fluid communication from the resistive heating element to the cooking chamber. The air duct may be provided with at least one damper to selectively inhibit air flow. At least one fan may provide air flow within the air duct.

At least one additional resistive heat source may be in the air duct.

The system may comprise an element box below the cooking surface wherein at least one resistive heating element is housed. Some embodiments comprise a controller controlling operation of the at least one resistive heating element and at least one damper.

The invention of the present disclosure, in another aspect thereof, comprises a cooking device including a cooking chamber having a cooking surface therein, an element box below the cooking chamber, a resistive heating element in the element box, an alternating current power source connection, a direct current power source, an air duct providing fluid communication between the element box and the cooking chamber, and a fan operable to move air through the air duct from the element box to the cooking chamber. The resistive heating element is powered by the alternating current power connection and the direct current power source.

The device may further comprise a first booster heating element in the element box and powered by the direct current power source, a second booster heating element in the air duct, and a plurality of dampers controlling air flow from the air duct into the cooking chamber. In some embodiments a controller selectively operates the fan and opens the plurality of dampers based upon at least a temperature probe reading from the cooking chamber.

### BRIEF DESCRIPTION OF THE DRAWINGS

FIG. 1 is a control schematic diagram of an electric cooking grill with improved convective heating characteristics according to the present disclosure.

FIG. 2 is a schematic diagram of an electric cooking grill with improved convective heating characteristics according to the present disclosure.

FIG. 3 is a schematic diagram of another electric cooking grill with improved convective heating characteristics according to the present disclosure.

FIG. 4 is a simplified schematic wiring diagram of an electric cooking grill with improved convective heating characteristics according to the present disclosure.

FIG. 5 is a simplified schematic wiring diagram for an electric cooking grill with improved convective heating characteristics utilizing a super capacitor according to the present disclosure.

FIG. 6 is a simplified schematic wiring diagram for an electric cooking grill with improved convective heating characteristics utilizing both a battery and a super capacitor according to the present disclosure.

FIG. 7 is a flowchart depicting a control method for an electric cooking grill with improved convective heating characteristics according to the present disclosure.

FIG. 8 is a flowchart depicting another control method for an electric cooking grill with improved convective heating characteristics according to the present disclosure.

### DETAILED DESCRIPTION OF THE PREFERRED EMBODIMENTS

According to various embodiments of the present disclosure, wasted heat can be transferred into a cooking surface/volume using means of convective transfer (e.g., after the radiation is captured by proper surface). Thus, a mechanism exists to complement the energy generation by enhanced energy transfer. Such mechanism should may able to direct/redirect the heat generated by the Calrod® element or another electrical heating element into the cooking surface/volume as needed, while limiting the level and impact of undesired heat loss via drafts (such as during periods when the lid is open during the cooking). Thus, the present disclosure provides for a smart mechanism to manage/optimize convective heat transfer (enhance or limit transfer rate as needed) in order to complement the electric grill's mostly radiative heat generation system.

According to embodiments of the present disclosure, an electric grill has enhanced cooking capability. Enhancements include, but are not limited to, allowing a cooking system to fully deploy available electrical power, and reducing warmup and recovery times.

In various embodiments, the improvements may be captured by at least two mechanisms. A first mechanism comprises capturing all, most, or more of the heat available. This may mean eliminating heat loss (e.g., the radiative heat escaping through wide opening under the grill and/or through fully open cooking grates similar to the ones used in gas grills) and also allowing for the heating elements to fully employ all the supplied electric energy.

A second mechanism is to couple the discharge of this additional energy with controlled convection (e.g., by pulsing a fan). A control system manages both the heat generation rate and heat transfer rate. The control system may manage the variations of the energy discharge in addition to when and where it is deployed.

In effect, some embodiments of the present disclosure provide a device that operates as an electric grill using radiant heating, but also has a fan to alter convective heat and air flow to tune the operation of the grill to various conditions. Thus, the conditions provided by radiant heating are augmented by alteration of convective air flow and/or convective heating. The augmentation can be to increase or decrease temperature and/or alter other cooking parameters.

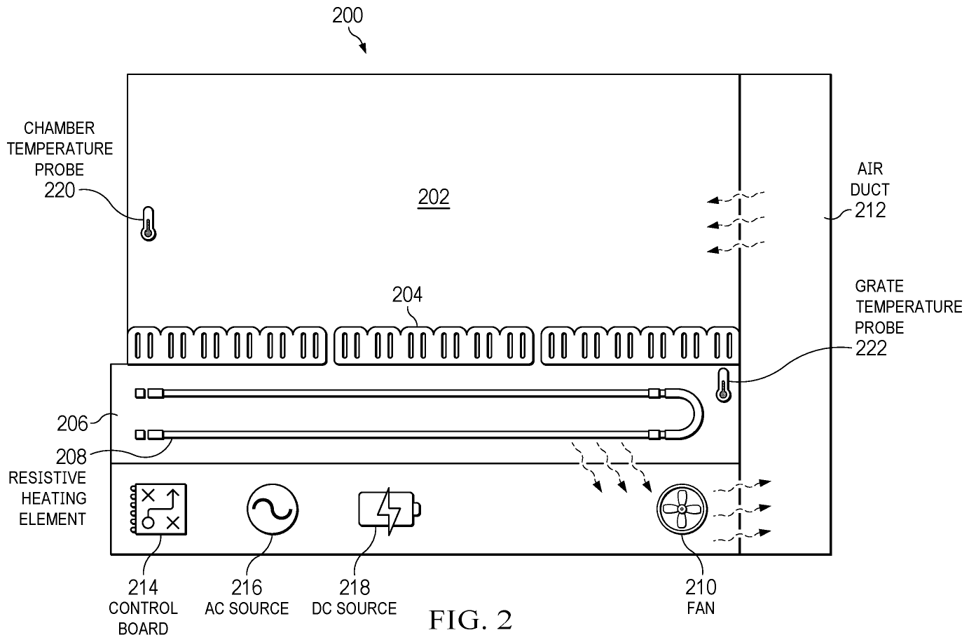

Referring now to FIG. 2, an electric grill 200 according to the present disclosure may comprise a cooking chamber 202 containing a cooking grate 204. The cooking grate 204 may be placed over an element box 206 containing an electric heating element 208, which may comprise a Calrod® heating element. The heating element 208 alone, or in combination with other components of the electric grill 200 may provide heat to the cooking grate 204 and/or cooking chamber 202.

According to some embodiments, measured/controlled air flow enhancing heat transfer from the heating element 208 towards the cooking surface or cooking grate 204 and cooking chamber 202 can be provided by an electromechanical component such as a fan 210, which may be a variable speed fan. The provided airflow from the fan 210 may can prevent the heating element 208 from overheating and from thermal runaway.

The controlled air flow of the electric grill 200 is complemented with an arrangement that prevents heat loss into the ambient atmosphere through unnecessary free convection. To achieve this end, the cooking system 200 may be designed as a heat reservoir with a fully controlled air supply. The fan 210 is placed at the upstream of an air channel 212 or duct that is the only passageway for the air going into the cooking chamber 202 from the element box 206. The system 200 minimizes the flow of ambient air into the cooking grate 204 and cooking system 200 (by pausing the fan 210), when the system 200 or cooking chamber 202 is at its desired temperature. Also, when the system 200 detects a lid to the cooking chamber 202 is at an open position (e.g., via a lid opening sensor), it can block airflow to diminish the heat loss by means of a buoyancy driven draft (e.g., by pausing the fan 210 or closing a damper as discussed below). The fan 210 can also reverse the direction in order to pull air into the heating element box (at a relatively low flowrate) to counterbalance the buoyancy force.

Systems of the present disclosure may have an electronic control board 214 having necessary relays, controls, switches, and controllers to control and implement the cooking modes and other operations discussed herein. One of skill in the art will appreciate there may be numerous ways to implement a control system based on combinations of hardware and software. For simplicity, not all leads, relays, etc. are shown. Systems of the present disclosure may also rely on an alternating current (AC) source 216, which may comprise household current. Systems may also rely on a direct current (DC) source 218, which may comprise a battery or capacitor, for example.

In situations when a higher rate of energy transfer is required (e.g., when grill 200 is just turned on in an extreme cold ambient temperature, or when several large pieces of raw meat are placed on the grate 204), the control system 214 increases the rate of electric power delivered to the heating element 208 and after a short period of time (accounting for the response time of the resistive element) it may start and/or run the fan 210 to complement the higher rate of heat generation with the higher rate of the heat transfer.

Controlled air flow is a primary mechanism that enhances the heat transfer from the heating element 208 into the cooking chamber 202 and to the cooking grate 204. This is achieved by both increasing the heat transfer coefficient around the heating element 208 and by having a directional transfer of the radiative heat absorbed by the surfaces under the heating element (e.g., the bottom of the element box 206) towards the cooking surface or grate 204 as the heated air travels into the cooking region 202.

Some operations of the systems of the present disclosure rely on temperature information at various locations in the system. A temperature probe 220 may be placed within the cooking chamber 202. Another temperature probe 222 may be placed to obtain a temperature of the cooking surface 204 or another location. The temperature probes 220, 222 may be solid state temperature probes or any suitable temperature probe known to the art. Additional temperature probes could be utilized to obtain an average reading across the desired locations (e.g., within the cooking chamber 202, at the cooking grate 204, and/or at the various resistive heating elements used by the systems of the present disclosure).

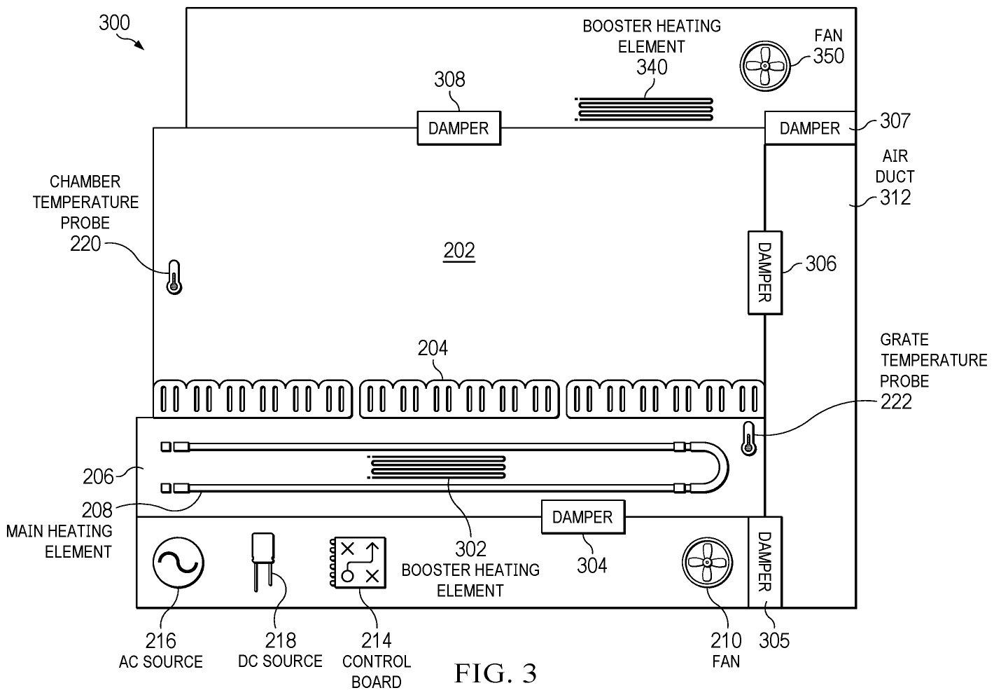

Referring now to FIG. 3, a schematic view of an electric grill 300 according to the present disclosure is shown. The grill 300 shares some common components with the grill 200. The grill 300 has a booster heating element 302 near heating element 208. The heating element 302 may be a Calrod® element or another heating element. An air duct 312 may provide multiple passageways to allow heated air into the cooking chamber 202, and these may be openable or closable by dampers 306, 308. Similarly, one or more dampers 304, 305 may open or close access for air flow from the element box 206 into the air duct 312.

A separate booster or complementary heating element 340 may be located somewhere within the air duct 312. An additional electric fan 350 may control air flow across the complementary heating element 340 and within the air duct 312 to promote air flow into the cooking chamber 202. The complementary heating element 340 may comprise a Calrod® heating element or another heating element.

As shown in FIG. 3, it is therefore possible to have a small heating element 340 coupled with a small fan 350 in the air duct 312 blowing air (either fresh from outside or recirculated from the cooking chamber 202) over the complementary heating element 340 and sending hot air into the cooking chamber 202. According to some embodiments, the rate of the power consumption of the coupled fan 350 and complementary heating element 340 is noticeably lower of the power consumed by the main heating element(s) 208 heating the cooking grate(s) 204.

In some embodiments, a higher rate of supply power also can be based on a complementary DC source 218 (such as a rechargeable battery or a supercapacitor). The boost power can be provided to the same main heating element(s) 208 or to supplementary element(s) 302. The supplementary element 302 or element can be positioned adjacent to the main element 208 or elements under the cooking grate 204 or positioned at the perimeter of cooking a region to provide additional heating around the periphery of the cooking grate 204 where heat loss to the outside environment is present.

In some embodiments, the system 300 is equipped with an air manifold or duct 312 with different channels that are controlled with the dampers 304, 305, 306, 308. Depending on where a higher heating rate is needed (e.g., cooking grate 204 or cooking chamber 202) the control system 214 directs the flow of hot air into the proper medium (e.g., using the dampers 304, 305, 306, 308).

In some embodiments, the systems 200, 300 are equipped with a smokebox to generate complementary smoke from a solid fuel. The control system 214 may direct the airflow into the smokebox to enhance the smoking and circulate the smoke into the cooking chamber 202.

In some embodiments, the systems 200, 300 are equipped with a secondary heating element placed above the cooking region (e.g., under a lid to the cooking chamber 202). The control system 214 may direct the airflow past the top heating element to increase the heat transfer coefficient and therefore enhance the heat transfer inside the cooking chamber 202.

In various embodiments, different types of DC sources are available. For example, one may be used to boost the heating of the cooking grate 204 and the other another may be used to boost heating of the cooking chamber 202. Such system may have one or more fans to enhance the heat transfer from the heating element(s) towards the cooking grates and/or cooking chamber as shown herein or otherwise. Fans according to the present disclosure can be constant speed or variable speed. The control system 214 can run the fan constantly or pulse the fan as determined by the control algorithm based on the setpoint and/or temperature readings. In various embodiments, the heat sources or heating elements may all be placed under the cooking grate 204 or also above the cooking chamber 202.

The air ducts 212, 312 may have outlets that are always open or can be equipped with one or multiple dampers (e.g., dampers 304, 305, 306, 308, or otherwise). The dampers' positions can be adjusted manually or automatically (for example, using an electric motor). The systems 200, 300 may be comprised multiple modular cooking subsystems in order to create the equivalent of multi-burner gas grill with higher precision and more distinguishable zones.

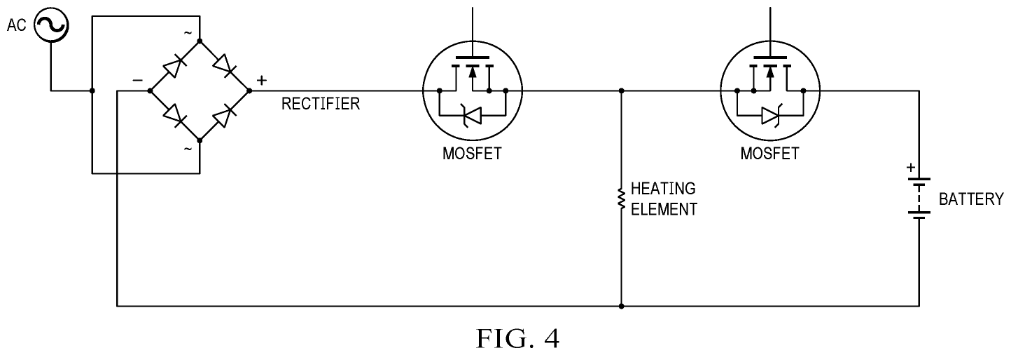

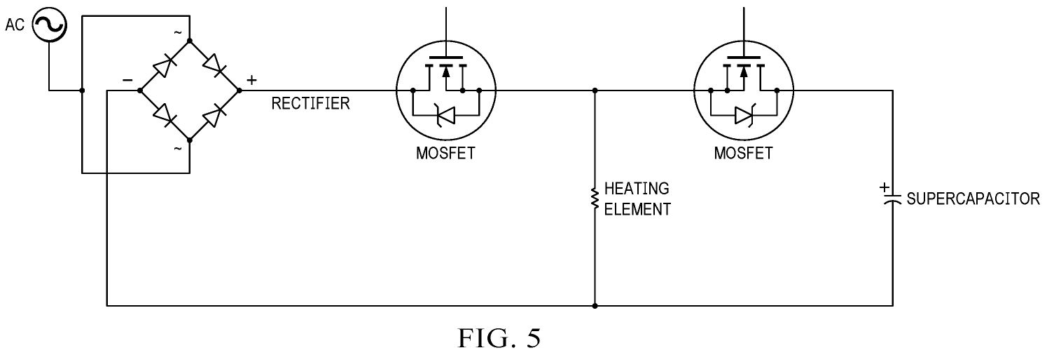

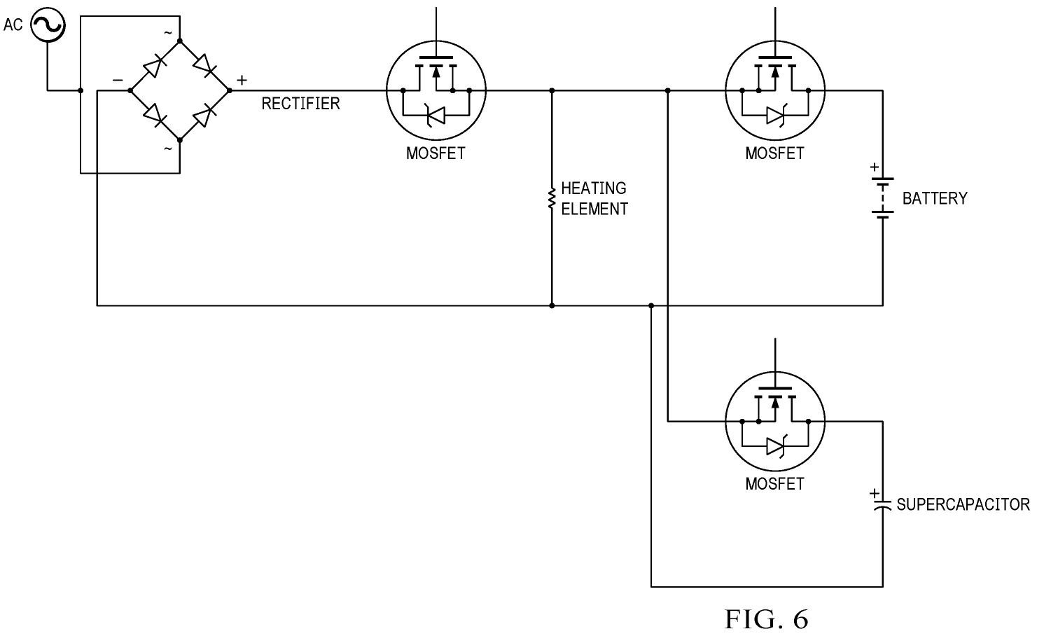

FIG. 4-6 illustrate different configurations of an electric circuit of the present disclosure in which a Calrod® or other resistive heating element as typically powered using AC mains is boosted by a DC power source such as a battery or supercapacitor. The discharge control of the DC power sources (battery, supercapacitor, capacitor, etc.), to boost the power of the Calrod®, using solid state components such as MOSFETs, is dictated by the smart control functionality described in this document.

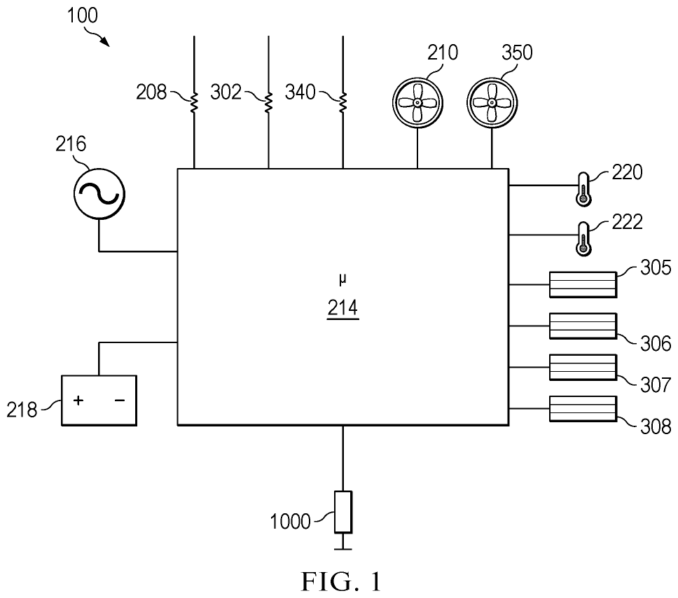

Referring now back to FIG. 1, a control schematic diagram 100 of an electric cooking grill with improved convective heating characteristics according to the present disclosure is shown. The diagram 100 is simplified in that relays, resistors, grounds and other circuit components that may be needed, and as are readily known in the art, are not shown. The AC power supply 216 as well as the DC power supply 218 may be available to the control board 214 for implementing the various functions described herein, and for powering the control board 214 itself. The control board 214 may have functionality to utilize the AC source 216 and/or the DC source 218 for any of the controlled components according to power requirements or the control method being executed.

The control board 214 may comprise a solid state programmable device such as a microprocessor or microcontroller having an appropriate memory and instructions to execute the control methods described herein. The control board may have operational control over fans 210, 350 such that they may be turned on or off, or controlled for speed (if the fans 210, 350 are multi-speed fans).

Temperature information may be provided to the control board via connection to the temperature probes 220, 222. Further information may be provided about the current state of the system via lid sensor 1000 (e.g., to indicate whether the a lid is open or closed, thereby indicating draft conditions) or other sensors. The various dampers 305, 306, 307, 308 may be electronically controlled by the control board 214 (e.g., utilizing actuators, servos, or other devices known to the art).

The resistive heating elements 208, 302, 340 and possibly other (e.g., those associated with a smoke box) may be controlled by the control board 214 according to the methods described herein. Power requirements of the resistive heating elements 208, 302, 340 and other components of the systems of the preset disclosure may be such that the control board 214 or a controller selectively connects these to power (e.g., the AC source 216 and/or the DC source 218) via relays or other devices known to the art.

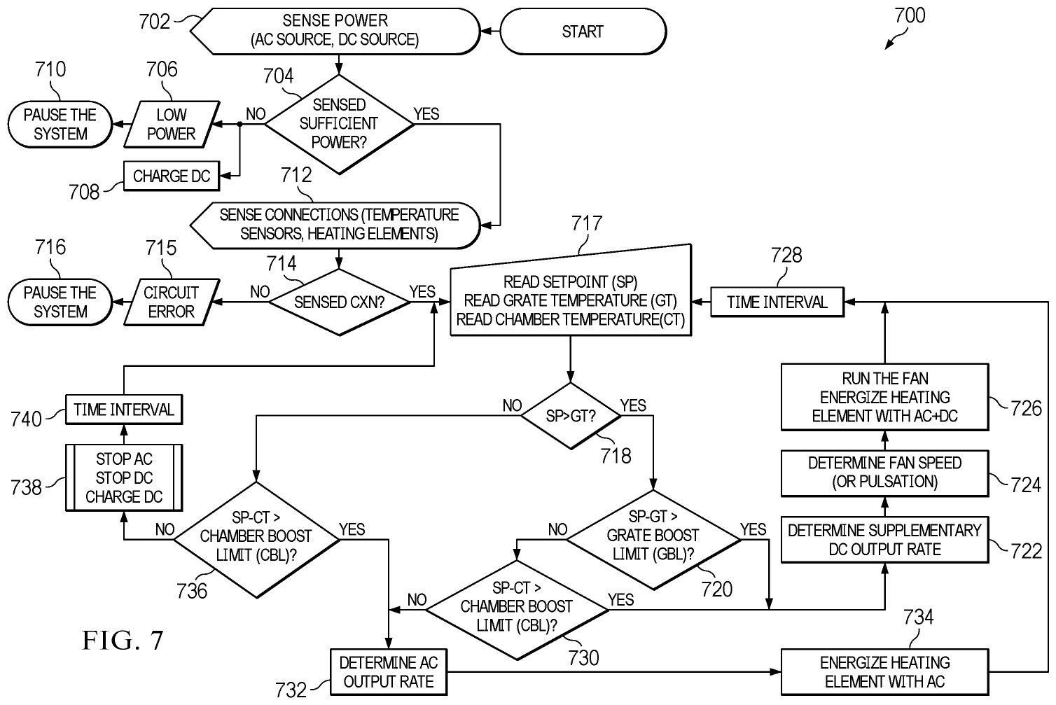

Referring now to FIG. 7, a flowchart 700 of a control method for a system according to the present disclosure is shown. Such systems enhance the heat generation (from AC and DC sources) and heat transfer (using a variable speed fan or pulsation of a fan) into a grill based on data provided by multiple temperature probes. The probes 220, 222 may be placed as shown in FIGS. 2-3 or otherwise.

At 702 power is sensed including the AC and DC sources. At 704 if insufficient power is available for the requested operation a low power signal is indicated at 706, which may pause system at step 710, while the DC source is charged at step 708. The pause, and need for charging may be indicated to the user via control screen or other device.

If sufficient power is available, sensing of connections may occur at step 712. This may include sensing connection of temperature sensors, heating elements, or other devices. If any connections are absent or faulty at step 714, an error may be indicated to the user at 715, and the system paused at step 716.

With properly sensed connections, setpoint, grate temperature, and chamber temperature may be read at step 717. At step 718 it is determined whether the setpoint is higher than the grate temperature. If not, at step 736 it may be determined whether a difference between the setpoint and the chamber temperature exceeds a chamber boost limit. If not, AC and DC energizing may be halted while DC may be charged at step 738. A time interval may be allowed to pass at step 740 before the reading step at 716 repeats.

On the other hand, if the difference between the setpoint and chamber temperature exceeds the chamber boost limit at step 736, an AC output rate may be determined at step 732 following by energizing the heating element with AC only at step 734. Following this, a time interval may be allowed to pass at 728 before returning to the reading step at step 716.

Returning to step 718, if the setpoint is higher than the grate temperature, it may be determined whether a difference between the setpoint and the grate temperature exceeds a grate boost limit at step 720. If so, a supplementary DC input rate is determined at step 722. Following this, a fan speed (or pulsation, or other control parameters) is determined at step 724. At step 726 the fan is operated and the heating element energized according to the determined parameters. A time interval delay may occur at step 728 before control returns to step and step 716.

If the difference between the setpoint and grate temperature does not exceed the grate boost limit at step 720, but the difference between the chamber temperature and setpoint exceeds the chamber boost limit at step 730, the DC supplement rate is determined at step 722 and control continues as charted in any event. If the difference between the chamber temperature and setpoint does not exceeds the chamber boost limit at step 730, the AC rate is determined at step 710.

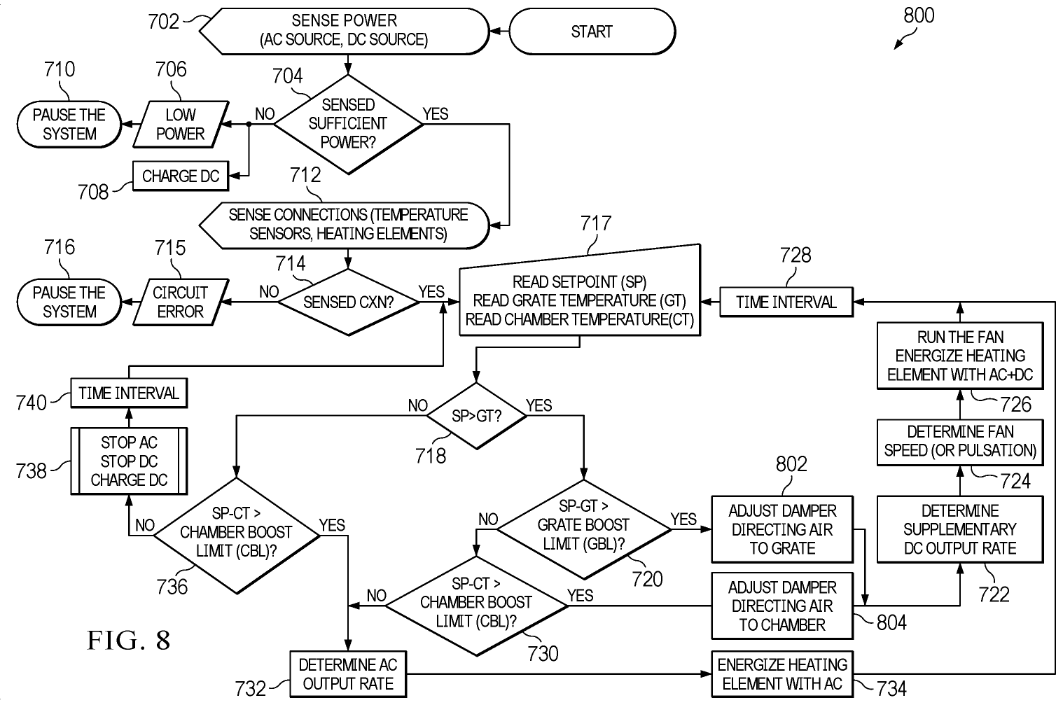

Referring now to FIG. 8, another flowchart 800 shows another control method that may be used for grills equipped with adjustable air passageway to direct the heated air either towards the cooking grates or into the cooking chamber as determined to be more beneficiary to the grilling experience, as described above. The illustrated flowchart 800 show a scenario with one heating element. Alternatively, there can be more than one heating element and each can be energized independently of each other or in synergy with each other.

As can be seen, the flowchart 800 shares the step described above with respect to flowchart 700. However, prior to determining the supplemental DC output rate at step 722 air dampers are adjusted at step 802 once it is determined at step 720 that the difference between the setpoint and grate temperature exceeds the grate boost limit. Similarly, dampers are adjusted at step 804 following a determination at step 730 that the difference between the setpoint and the chamber temperature is greater than the chamber boost limit. In either case, control then continues to step 722 to determine the supplementary DC output rate as previously described.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%.

When, in this document, a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

The term “selective” or “selectively,” unless otherwise indicated, is taken to mean that the operation or function is capable of being performed by the structure or device in reference, but the operation or function may not occur continuously or without interruption. Furthermore, a selective or selectively performed operation may be one that the user or operator of a device or method may choose whether or when to perform, but the function or operation is nevertheless fully operative on or within the relevant device, machine, or method and the same includes the necessary structure or components to perform such operation.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A cooking system comprising:
a cooking chamber having a cooking surface therein;
at least one resistive heating element providing heat to the cooking surface;
an alternating current connection for powering the resistive heating element; and
a direct current source selectively powering at least one resistive heating element simultaneously with the alternating current connection.

2. The system of claim 1, wherein the direct current source comprises a chemical battery.

3. The system of claim 1, wherein the direct current source comprises a capacitor.

4. The system of claim 1, further comprising at least one temperature probe measuring a temperature associated with the cooking chamber.

5. The system of claim 4, further comprising a control circuit that selectively activates the direct current source based upon readings taken from at least one temperature probe.

6. The system of claim 4, wherein the at least one temperature probe comprises a cooking chamber temperature probe and a resistive heating element temperature probe.

7. The system of claim 6, wherein at least one resistive heating element comprises at least a first resistive heating element powered by the alternating current connection and at least a second resistive heating element powered by the direct current source.

8. The system of claim 7, wherein the control circuit determines whether a difference between a set point temperature and a temperature from at least one probe exceeds a boost threshold before activating the direct current source to power at least one resistive heating element.

9. The system of claim 1, wherein the alternating current connection recharges the direct current source.

10. The system of claim 1, further comprising an air duct providing fluid communication from the resistive heating element to the cooking chamber.

11. The system of claim 10, wherein the air duct is provided with at least one damper to selectively inhibit air flow.

12. The system of claim 11, further comprising at least one fan providing air flow within the air duct.

13. The system of claim 12, further comprising at least one additional resistive heat source in the air duct.

14. The system of claim 13, further comprising an element box below the cooking surface wherein at least one resistive heating element is housed.

15. The system of claim 11, further comprising a controller controlling operation of the at least one resistive heating element and at least one damper.

16. A cooking device comprising:
a cooking chamber having a cooking surface therein;
an element box below the cooking chamber;
a resistive heating element in the element box;
an alternating current power source connection;
a direct current power source;
an air duct providing fluid communication between the element box and the cooking chamber; and
a fan operable to move air through the air duct from the element box to the cooking chamber;
wherein the resistive heating element is powered by the alternating current power connection and the direct current power source.

17. The device of claim 16, further comprising:
a first booster heating element in the element box and powered by the direct current power source;
a second booster heating element in the air duct; and
a plurality of dampers controlling air flow from the air duct into the cooking chamber.

18. The device of claim 17, further comprising a controller selectively operating the fan and opening the plurality of dampers based upon at least a temperature probe reading from the cooking chamber.
